(19) United States
(12) Patent Application Publication
(10) Pub. No.: US 2015/0280935 A1
(43) Pub. Date: Oct. 1, 2015

(54) THERMOSTAT CODE INPUT SYSTEM AND METHOD THEREFOR

(71) Applicant: BRAEBURN SYSTEMS, LLC, Montgomery, IL (US)

(72) Inventors: Daniel S POPLAWSKI, Oswego, IL (US); Ernest E SODERLUND, Hampshire, IL (US)

(21) Appl. No.: 14/671,535

(22) Filed: Mar. 27, 2015

Related U.S. Application Data
(60) Provisional application No. 61/971,241, filed on Mar. 27, 2014.

(51) Int. Cl. H04L 12/28; G05D 23/19

(52) U.S. Cl. CPC H04L 12/2818; G05D 23/1919

(57) ABSTRACT

The invention provides a method of inputting a code to a thermostat comprising the following steps, providing a thermostat having a display panel and a receiver for receiving signals from a local router, the local router configured to receive signals via the internet from a remote wireless device (RID), transmitting a register command to the local router, transmitting new user information to the local router and the thermostat receiving network information from the RID and the thermostat synchronizing with the RID without requiring any direct code inputs to the display panel of the thermostat.

This application claims priority to Provisional application No. 61/971,241 filed on Mar. 27, 2014.

The present invention pertains to an heating, ventilation and/or air conditioning (HVAC) control system that accommodates and facilitates control from a remote device.

### BACKGROUND

HVAC control systems are used to control the environment within a building and are more frequently linked via the internet for web-enabled building control. The internet connection allows receipt of instructions from a remote and/or mobile device. However, there are many levels of complexity that can lead to difficult implementation and use of such controllers. For example, many wireless network communication protocols exist, such as Bluetooth, DSRC, EnOcean, IrDA, Redlink, RFC, Wi-Fi or Zigbee®. These wireless network communications must reliable link to components such as routers, hubs, sensors, computers, mobile phones or tablets and thermostats. A multitude of software and graphical user interfaces may be used to attempt to set-up and control the systems. All of this complexity can lead to layers of technical problems for the system installers and unsophisticated users. In particular, many users have difficulty with set-up procedures when there are a multitude of steps required to link the components of the system. The present invention overcomes many of such difficulties and provides for easy set-up and synchronization between a remote device and a HVAC control.

### SUMMARY

The present invention provides for a method of inputting a code to a thermostat comprising the steps of providing a thermostat having a display panel and a receiver for receiving signals from a local router, the local router configured to receive signals via the internet from a remote input device (RID), receiving by the local router a register command from the RID, receiving by the local router new user information from the RID, disconnecting the RID from the local router, connecting the RID to the thermostat and the thermostat receiving a password from the RID and the thermostat synchronizing with the RID without requiring any direct code inputs to the display panel of the thermostat.

The present invention provides for the local router providing a Wi-Fi network and the method including the step of receiving a Wi-Fi password at the thermostat. The thermostat may use software tools to synchronize with the RID in one step. The remote server may send a message to the thermostat that a user account has been created successfully and a successful account creation message is transmitted to the RID such as a wireless phone. The local router may transmit to the RID an alert transmission that no valid internet connection is available, that there is a communication loss, there is an unknown error, or other types of alerts.

The present invention allows a user to may obtain the serial number by examining an authentication card or a panel of the thermostat where the serial number is displayed and inputting the serial number to the RID. The transmission of the device name may be input to the local router. The transmission of appropriate Wi-Fi network data is transmitted to the RID. A set-up protocol is transmitted to a remote server that transmits the set-up protocol to the local router to associate the thermostat with the RID without requiring a single direct code input by the user to the thermostat and the display panel of the thermostat is solely for manual control of the thermostat and there are no commands available on the display panel to synchronize the thermostat with the remote input device (RID).

In an embodiment a thermostat configured for remote control comprises a display panel of the thermostat that is solely for manual control of the thermostat and there are no commands available on the display panel to synchronize the thermostat with a remote input device (RID) and a receiver disposed in the thermostat for receiving synchronizing codes from a local router, the local router capable of receiving instructions from the RID. The local router may be capable of receiving communications from a Wi-Fi network, the local router configured to transmit a Wi-Fi password to the thermostat. The thermostat may receive a signal from the local router that a user account has been created successfully.

In an embodiment a web enabled building control system comprises a web enabled control device linked to a first network, and for receiving synchronizing instructions via the first network, one or more building environment control devices coupled to the web enabled building control device over a second network, at least one of the one or more building environment control devices coupled to one or more HVAC units, the web enabled control device configured to receive sensor information from at least one or more building environment control devices via the second network, the web enabled control device configured to link with and receive information via a server displaying a web-page or app page including configuration information and building schedule information and a set-up protocol is received by the building environment control device over the second network without requiring a single direct code input by a user to configure the building environment control device in order to receive signals from the web enabled control device and a display panel of the building environment control device is solely for manual control and there are no commands available on the display panel to synchronize the building environment control device from a web-page.

The web enabled building control device may be adapted to issue commands to at least one of the building environment control devices via the second network to activate or deactivate one or more HVAC units. At least some of the commands may be based in part on received sensor information. At least some of the commands are based in part on building schedule information. The building environment control device is a thermostat having a display panel and there are no commands available on the display panel or via physical buttons to configure or synchronize the thermostat via a remote wireless device. The web enable building control device may be a remote server providing a Wi-Fi network that is configured to transmit a Wi-Fi password to the thermostat. The thermostat may use software tools to synchronize with the remote server in one step.

### BRIEF DESCRIPTION OF THE DRAWINGS

FIGS. 1-11 are screen shots of set-up displays for registering a user account and linking to a local router;

FIG. 12 is a flow diagram depicting the steps to configure and set-up a home comfort control device;

FIG. 13 is a schematic diagram of a household or building system for receiving configuration data from a remote wireless device to program a thermostat within the home;

FIG. 14 is a schematic diagram of the system of FIG. 13 depicted and linked to the internet.

While the invention is amenable to various modifications and alternate forms, specific embodiments have been shown by way of example in the drawings and will be described in detail, it should be understood that the intention is not to limit the invention to the particular embodiments described. The intention is to cover all modifications, equivalents and alternatives falling within the spirit and the scope of the invention.

### DETAILED DESCRIPTION

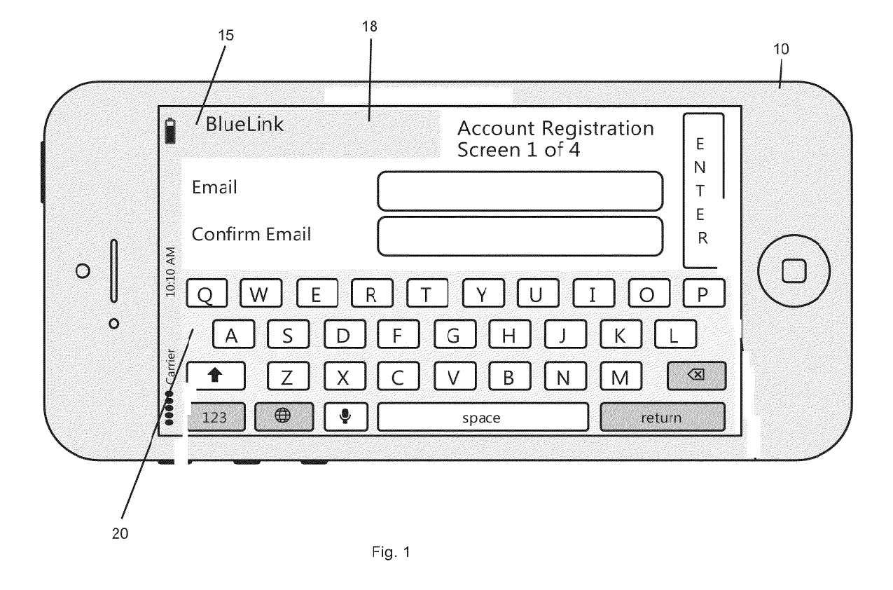

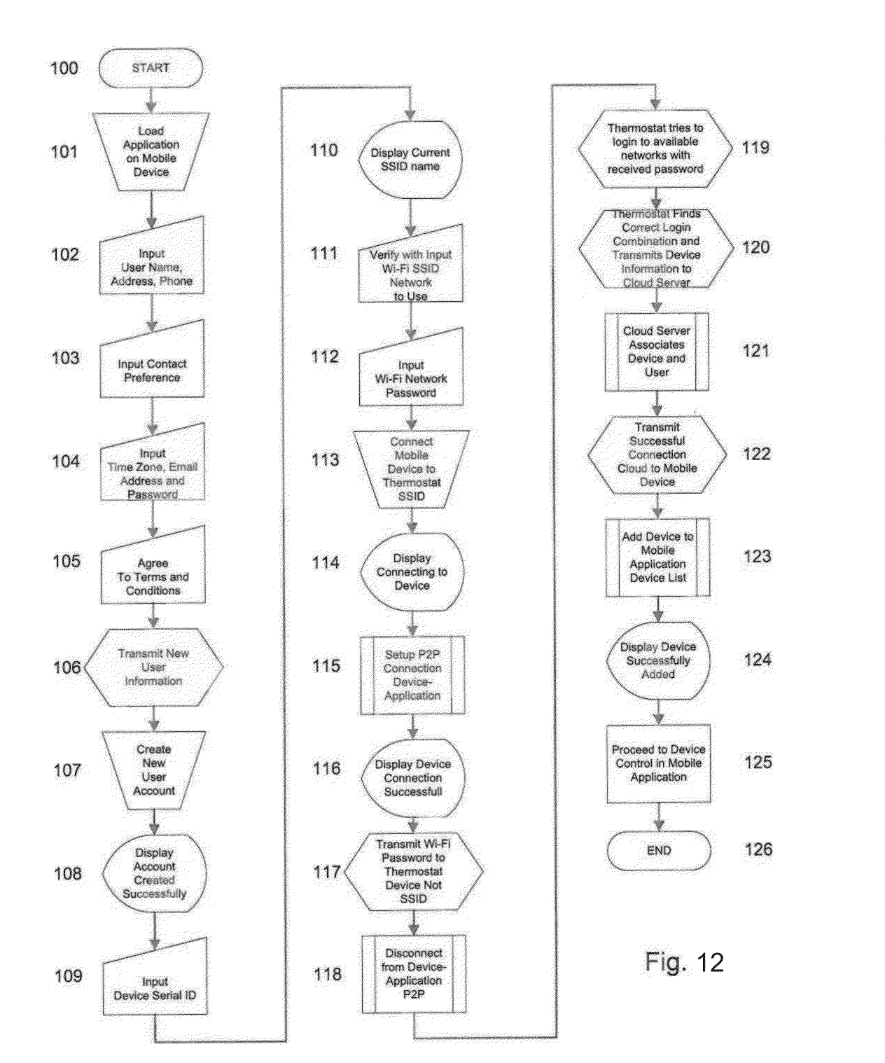

Turning to FIGS. 1-13, an embodiment of the invention will be described. FIGS. 1-11 depict screen shots of set-up displays that will be described in sequence according to the steps provided in FIG. 12. FIG. 1 depicts a remote input device (RID) such as a Smartphone or other device that is capable of transmissions using Wi-Fi or WLAN under IEEE Communication Standard 802.11, or any other well-known wireless communication system. It is well known to use encryption means to send data and each of the data transmissions described below may be encrypted and decrypted. The RID may include a computer, tablet, phone, laptop, notebook, wireless computer, wireless tablet, wireless phone, wireless laptop or wireless notebook. The device 10 includes a touchscreen 15 including a data input area 18 and keypad area 20. Using well known systems such iPhone apps or Play apps from Google, or other well-known methods, the user starts the process at step 101 loading the (BlueLink™) application on a mobile device 10.

The display screen 18 depicts account registration screen 1 of 4 and includes empty input blocks for “Email” and “Confirm email” input blocks. A user types on the keypad 20 in order to input their email address. This coincides with Step 102 of FIG. 12. While the display screens of FIGS. 1-11 have specific graphical user interface (GUI) layouts, the invention may be implemented using other types of GUIs and layouts. The invention may also be implemented with similar set-up commands via a web page on a remote input device including wired or wireless computers and/or wireless smartphones or tablets.

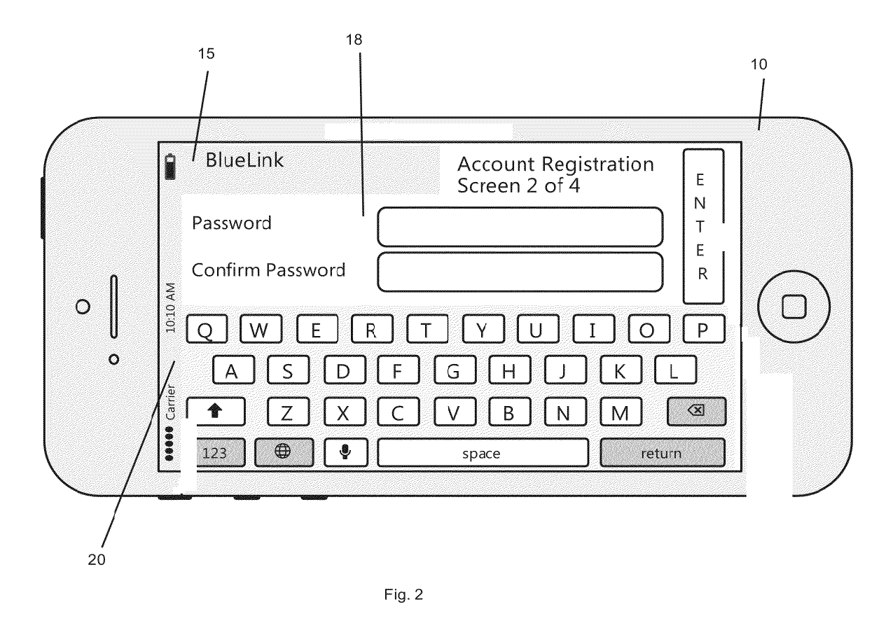

Turning to FIG. 2, the account registration screen 2 of 4 is depicted in the display area 18 and the user inputs a password and confirms the password in accordance with Step 103 of FIG. 12.

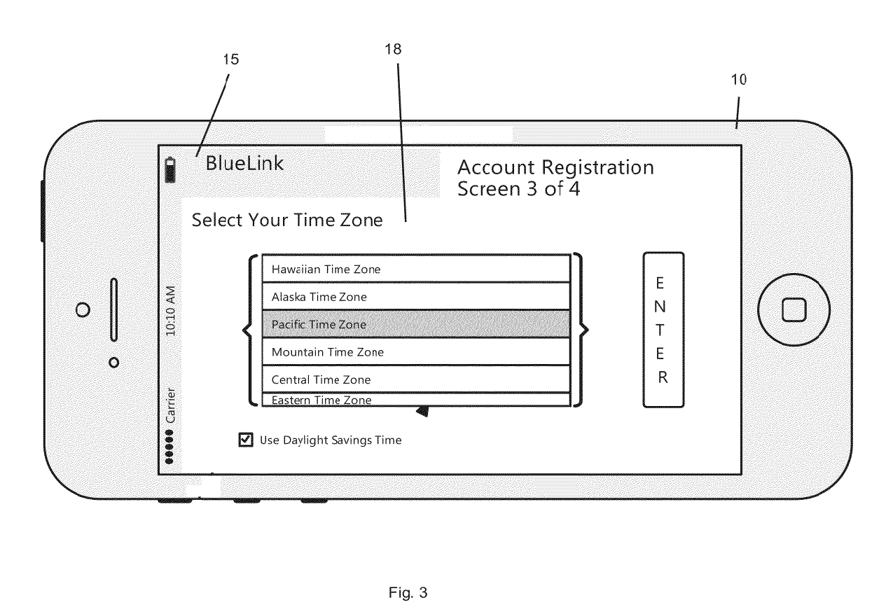

Turing to FIG. 3, the account registration screen 3 of 4 is depicted in the display area 18. Note that the keyboard area 20 has been removed and in this embodiment a time zone is selected by touching the screen. For example, when the “Pacific Time Zone” is selected, it will be highlighted in grey. This step is shown in FIG. 12 as Step 104.

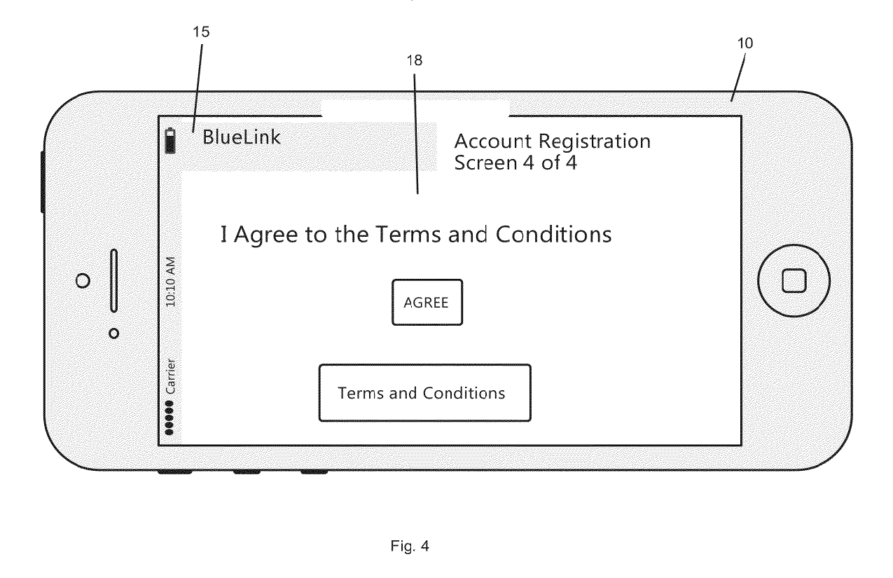

FIG. 4 depicts account registration screen 4 of 4 where the user agrees to the terms and conditions by pressing the “Agree” button or reviewing terms and conditions by pressing the “Terms and Conditions” button on the display area 18. This coincides with Step 105 of FIG. 12.

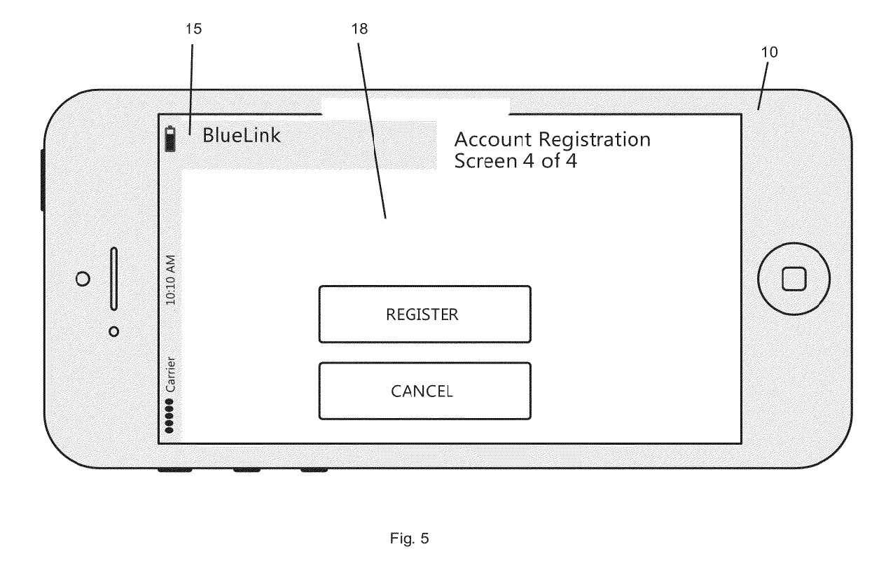

At FIG. 5, account registration screen 4 of 4 (continued) is displayed and allows the user to register by pressing the “Register” button on the display area 18 or to cancel the transaction by pressing the “Cancel” button. This coincides with Step 106 of FIG. 12. Upon selecting the Register button, the new user information will be transmitted.

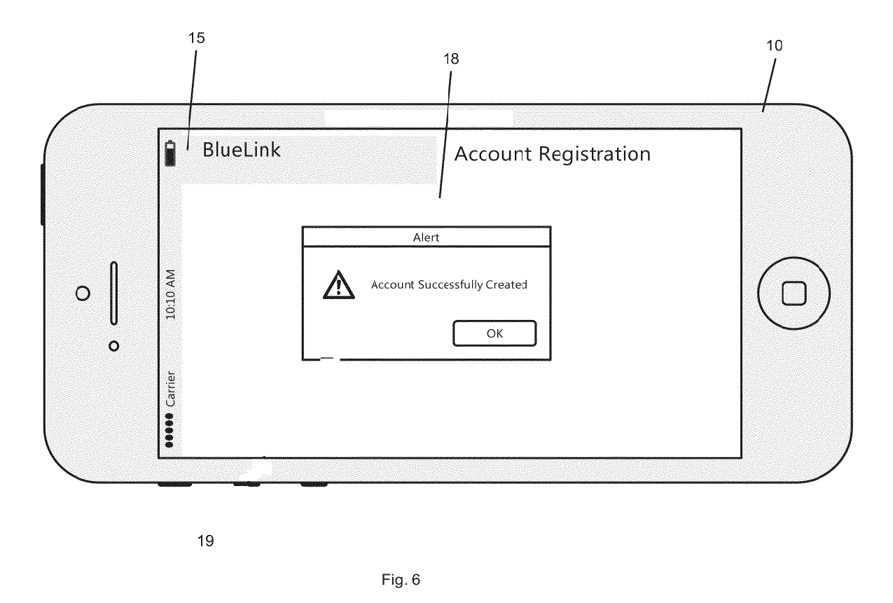

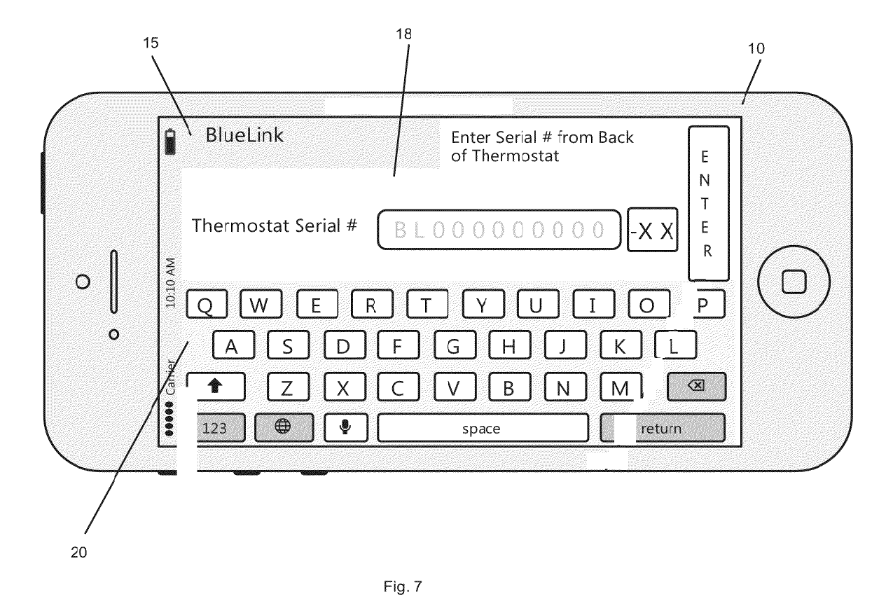

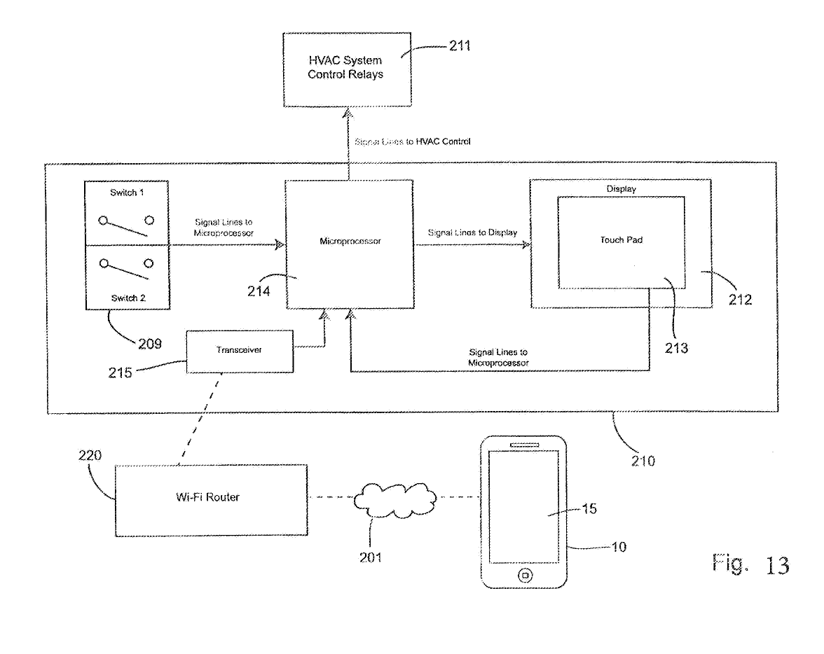

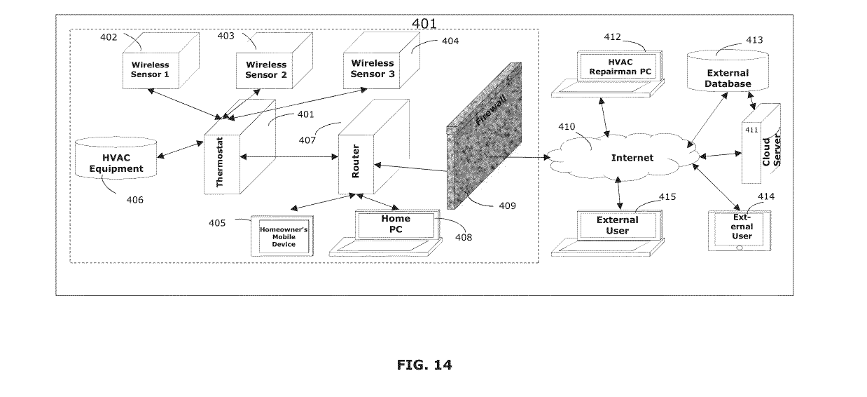

Turing to FIG. 12, following the transmission of the new user information to a cloud server 201 (FIG. 13) configured to handle transactions for this system (BlueLink), a new user account is created. Well-known means of creating customer accounts using software tools may be accomplished at this Step 107. At Step 108, the server sends a message that the account has been created successfully. As depicted in FIG. 6 on the display area 18 of the mobile device 10, a window is opened that states “Account Successfully Created”19. Other alerts that may be posted via the mobile device 10 include “No Valid Internet Connection,” “Communication Loss,” “Unknown Error,” or other types of alerts. At the next Step 109, the screen display area 18 changes and the keyboard area 20 is redisplayed so that the user can input the serial number of a thermostat or building environment control device. The user may view the back of the thermostat 210 (FIG. 13), 401 (FIG. 14) or user manual or authentication card where the serial I.D. number is displayed. Using the keypad 20, the user will enter the number in the block area in the display section 18 of the mobile device 10 as depicted in FIG. 7.

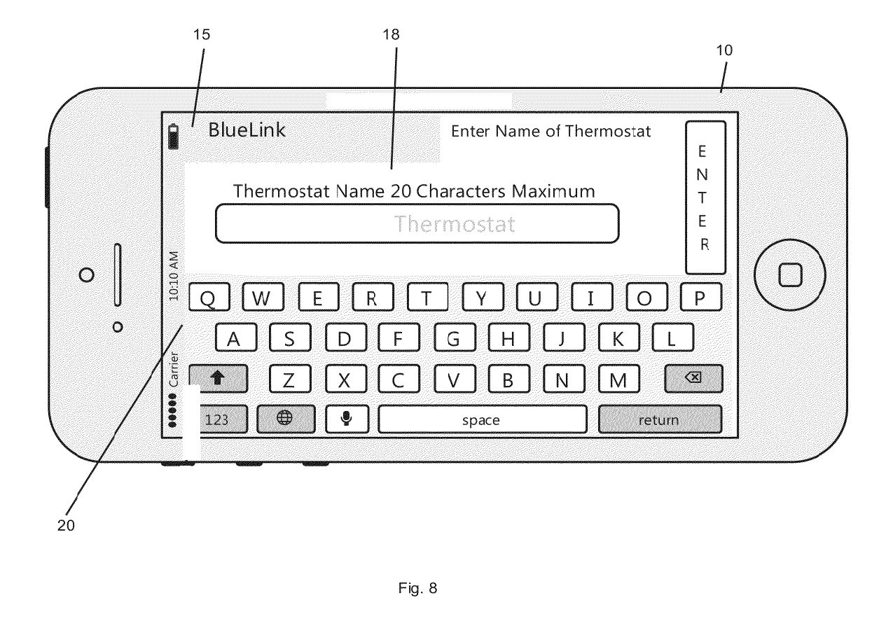

At Step 110, the device name is input by use of the keypad 20 and putting the user's desired name for the thermostat. For example, a default name of “Thermostat” will be used and if another name is entered, the default will be “Thermostat 2” and if a third default name is entered, the system will use the name “Thermostat 3”, etc., as shown in FIG. 8. In an alternate manner, the user may identify the thermostat as “Living Room,” “Dining Room,” “Family Room,” “Bedroom,” etc.

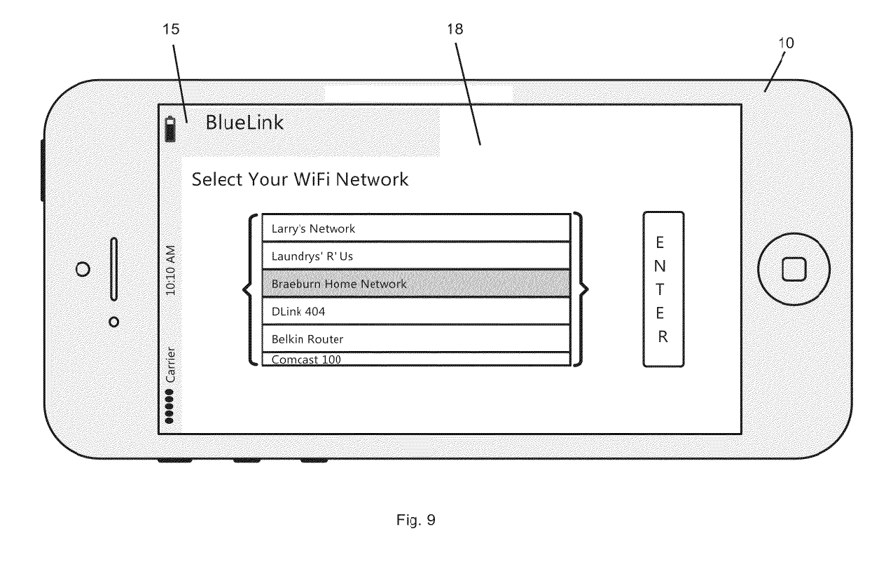

At Step 111, the synchronization of the system to work with a Wi-Fi network is depicted. As shown in FIG. 9, a display of local Wi-Fi networks is displayed and the user can select the appropriate Wi-Fi network by indicating with a fingertip on the touchpad display. For example, in FIG. 9, the user has selected “Braeburn Home Network” and that bar is highlighted in a darker color. The Wi-Fi network is provided by a local router 407 (FIG. 14) or other web enabled control device. Once the user has selected the preferred home network, they can depress the Enter button.

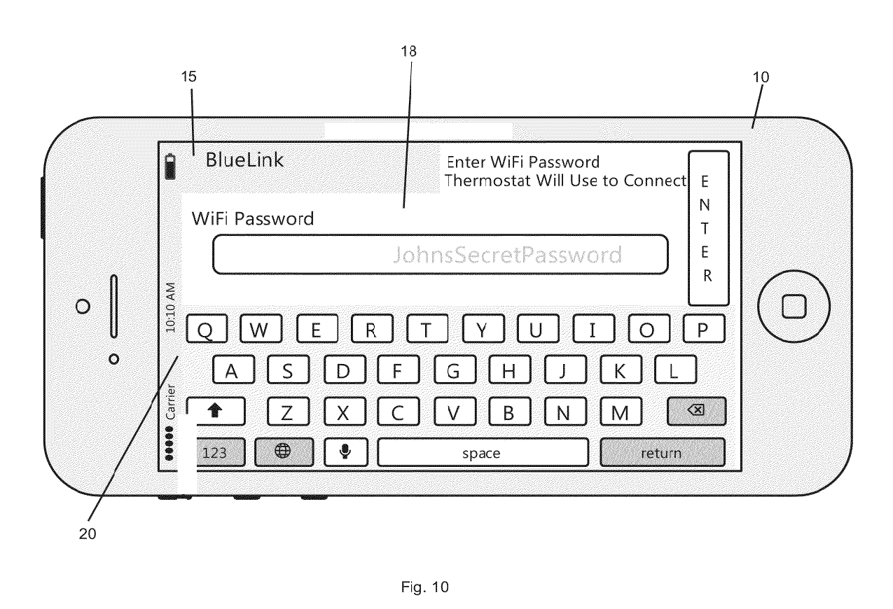

At Step 112, the application receives the identification of the Wi-Fi network to be used. At Step 113, the password for the Wi-Fi network is input into the display area 18 of the remote/mobile device 10. Once the application receives the password via input screen as shown in FIG. 10, the application will activate the communication via the Wi-Fi network to the thermostat and at Step 114 the thermostat device is put into an active listening mode. User input to the thermostat places the thermostat 210, 401 in the listening mode.

At Step 115, a display is provided by the mobile device that a connection is being made to the thermostat device 210, 401. At Step 116, a P2P set-up protocol is communicated to the application running on the thermostat 210, 401.

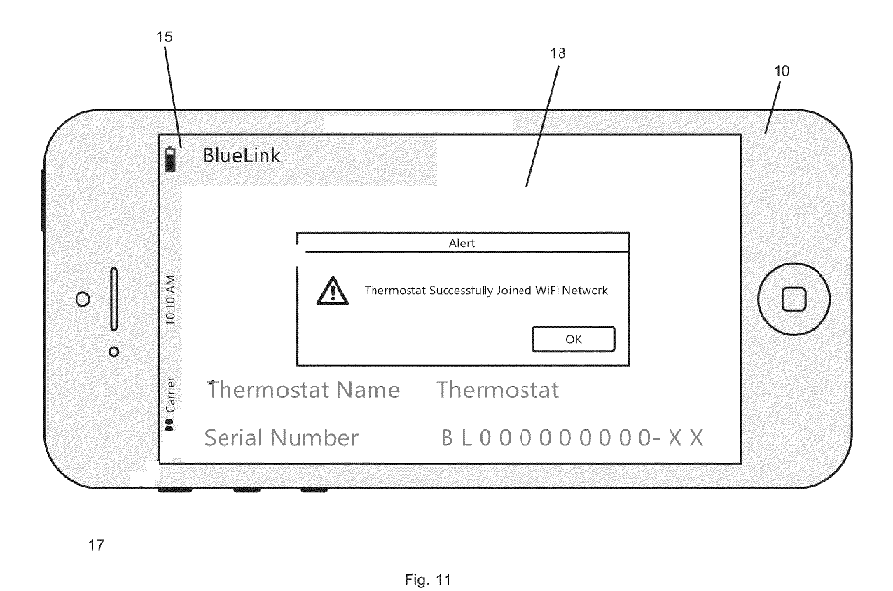

At Step 117, a display appears on the mobile device that the connection is successful as depicted at 17 in display area 18 depicted in FIG. 11. At Step 118, the application will transfer the Wi-Fi network selection and Wi-Fi password to the thermostat 210 (FIG. 13), 401 (FIG. 14) to set-up the thermostat 210 for control from the RID. This provides the set-up of the thermostat in one step.

At Step 119, the thermostat device 210, 401 is set up according to the instructions from a server via communication from the Wi-Fi network 407 (FIG. 14). At Step 120, the mobile device 10 transmits information to the server 411 via the Cloud (FIG. 14). At Step 121, the Cloud server 411 associates the user's mobile device via a unique serial number so that the mobile device 10 and the thermostat 210 (FIG. 13), 401 (FIG. 14) are synchronized.

At Step 122, a display on the mobile device 10 is displayed that the connection between the thermostat 210, 401 and the mobile device has been successful. At Step 123, the thermostat device 210, 401 is added to the app device list of the mobile device 10. At Step 124, a display is made on the hand-held mobile device 10 that the thermostat (as named previously in step 110) has been successfully added.

At Step 125, the application (app) 210, 401 on the mobile device 10 is enabled. Enablement allows for control of the thermostat 210, 401 to begin via the mobile device 10. Step 125 is the final step that completes the code input and set-up between the mobile device 10 and the thermostat 210, 401. It is noted that during the code input and set-up process, there is no requirement for the user to make any code inputs to the thermostat 210, 401 itself or to interact with the display screen on the thermostat itself. The present invention allows for the set-up process solely via the user's hand-held mobile device 10. As can be understood, following the set-up, the user can be anywhere in the world and control the thermostat via the mobile device with communications being sent through the standard telephone network to the Cloud and the Cloud server 201 (FIG. 13), 401 (FIG. 14) which can interact with the Wi-Fi network provided by the router 220 (FIG. 13), 407 (FIG. 14) at the user's residence or commercial facility 401 (FIG. 14).

FIG. 13 depicts a diagram of the entire system in schematic form. The mobile device 10, having been set-up and synchronized as describe above communicates via cloud server 201 to a WiFi router 220 located in a home or business. The router 220 communicates with the thermostat 210 via transceiver 215 that includes communication protocol for wireless transmission and receiver functions, such IEEE 802.11. The transceiver communicates with the microprocessor 214 to control the systems connected to the thermostat, such HVAC system control relays 211 that control a furnace or boiler, etc. In an embodiment the microprocessor 214 may be programmed to include wireless mesh communication as disclosed in U.S. Pat. Nos. 8,410,931 and/or 8,233,471 assigned to SIPCO, the total disclosure of such publications are each incorporated by reference herein.

It is noted that the thermostat 210 may include a touch pad display screen 212, however the operation and set-up of the above invention does not require the user to input any commands or instructions via the thermostat display 212. All set-up steps can be accomplished via a remote input device 10 running the communication app and code input system that causes the microprocessor 214 to move to a listen mode when the set-up steps 100 to 126 are followed, as discussed above. In an alternate embodiment, a remote computer (wired or wireless) may be used to set-up or control the thermostat 210 via the internet and a browser by similar set-up screens depicted in FIGS. 1-11 displayed on a web page according to well know TCP/IP systems.

FIG. 14 is a schematic view including the components of FIG. 13 and depicting the links outside of the thermostat 210 (FIG. 13), 401 (FIG. 14). The thermostat links with local router 407 and its Wi-Fi network that links to the internet or first network. External devices such as cloud server 411, personal computer of repairman or other service providers 412, external database 413, the external user's remote input device, such as a wireless tablet or phone 414 and other wired users 415 may communicate with the local router 407 (through firewall 409). The local router 407 can then communicate via Wi-Fi or other protocol such as Zigbee® on a second network with components including the thermostat 401 or other building environment control device that in turn can control HVAC equipment 406 including a furnace heat pump (electric geothermal), electric heat, air conditioning unit, humidifier, dehumidifier, air exchanger, air cleaner or air damper. The thermostat 401 may receive input from wireless sensors 402, 403, 404 that can provide temperature, humidity and other environmental factors either within the building 401 or outside that may be used by the router to automatically issue commands to the thermostat based on the sensor input or building schedule information. The code input system of the present invention may also be operated via web-site on a computer 408, 412 or other means and each of the components of the system 401, 402, 403, 404. 406 and 407 may have a unique identifier, such as an IP address. The router 407 may have a local cache to store the IP addresses when each device is joined to the network. The second network may require a service set identifier (SSID) as an access parameter or a passcode.

Numerous variations and modifications will become apparent to those skilled in the art once the above disclosure is fully appreciated. It is intended that the claims be interpreted to embrace all such variations and modifications.

What is claimed is:

1. A method of inputting a code to a thermostat comprising the following steps:
providing a thermostat having a receiver for receiving signals from a local router, the local router configured to receive signals via the internet from a remote input device (RID);
transmitting, by the RID, a register command to the local router;
transmitting, by the RID, new user information to the local router;
disconnecting the RID from the local router;
connecting the RID to the thermostat; and
the thermostat receiving a password from the RID and the thermostat synchronizing with the RID without requiring any direct user code inputs to the thermostat.

2. The method of claim 1 wherein the local router provides a Wi-Fi network and the method including the step of receiving a Wi-Fi password at the thermostat and the Wi-Fi network transmitting information to the thermostat in order to place the thermostat in a listen mode.

3. The method of claim 1 wherein the thermostat uses software tools to synchronize with the RID in one step.

4. The method of claim 1 wherein the thermostat receives a user input to place the thermostat in the listen mode.

5. The method of claim 1 wherein a successful account creation message is transmitted to the RID, the RID having a display and including one of a computer, tablet, phone, laptop, notebook, wireless computer, wireless tablet, wireless phone, wireless laptop, wireless notebook.

6. The method of claim 1 wherein the RID receives an alert transmission that no valid internet connection is available, there is a communication loss, there is an unknown error, or other types of alerts.

7. The method of claim 1 wherein a user obtains the serial number by examining an authentication card or a panel of the thermostat where the serial number is displayed and inputting the serial number to the RID.

8. The method of claim 1 wherein the transmission of the device name is input to the local router.

9. The method of claim 1 wherein the transmission of appropriate Wi-Fi network data is transmitted to the RID.

10. The method of claim 1 wherein a set-up protocol is transmitted to a remote server that transmits the set-up protocol to the local router to associate the thermostat with the RID without requiring a single direct code input by the user to the thermostat and a display panel of the thermostat is solely for manual control of the thermostat and there are no commands available on the display panel to synchronize the thermostat with the RID.

11. A thermostat configured for remote control comprising:
a display panel of the thermostat that is solely for manual control of the thermostat and there are no commands available on the display panel to synchronize the thermostat with a remote input device (RID); and
a receiver disposed in the thermostat for receiving synchronizing codes from a local router, the local router capable of receiving instructions from the RID.

12. The thermostat of claim 11 wherein the local router is capable of receiving communications from a Wi-Fi network, the local router configured to transmit a Wi-Fi password to the thermostat.

13. The thermostat of claim 11 wherein the thermostat may be placed in a listen mode by a user and the thermostat receives a signal from the local router that a user account has been created successfully.

14. A web enabled building control system comprising:
a web enabled control device linked to a first network, and for receiving synchronizing instructions via the first network;
one or more building environment control devices coupled to the web enabled building control device over a second network, at least one of the one or more building environment control devices coupled to one or more HVAC units;
the web enabled control device configured to receive sensor information from at least one or more building environment control devices via the second network;
the web enabled control device configured to link with and receive information via a server displaying a web-page or app page including configuration information and building schedule information;
a set-up protocol is received by the building environment control device over the second network without requiring a single direct code input by a user to configure the building environment control device in order to receive signals from the web enabled control device; and
a display panel of the building environment control device is solely for manual control and there are no commands available on the display panel to synchronize the building environment control device from a web-page.

15. The system of claim 14, wherein the web enabled building control device is further adapted to issue commands to at least one of the building environment control devices via the second network to activate or deactivate one or more HVAC units.

16. The system of claim 15, wherein at least some of the commands are based in part on received sensor information.

17. The system of claim 15, wherein at least some of the commands are based in part on building schedule information.

18. The system of claim 14 wherein the building environment control device is a thermostat having a display panel and there are no commands available on the display panel or via physical buttons to configure or synchronize the thermostat via a remote wireless device.

19. The system of claim 18 wherein the web enable building control device is a remote server providing a Wi-Fi network that is configured to transmit a Wi-Fi password to the thermostat.

20. The system of claim 19 wherein the thermostat uses software tools to synchronize with the remote server in one step following user input to place the thermostat in a listening mode.
